(19) United States
(12) Patent Application Publication
(10) Pub. No.: US 2016/0087499 A1
(43) Pub. Date: Mar. 24, 2016

(54) ELECTRIC MACHINE HAVING AN IMPROVED COOLING OF THE WINDING HEAD

(71) Applicant: SIEMENS AKTIENGESELLSCHAFT, München (DE)

(72) Inventor: FRANK SEIBICKE, Borkheide (DE)

(73) Assignee: SIEMENS AKTIENGESELLSCHAFT, München (DE)

(21) Appl. No.: 14/786,065

(22) PCT Filed: Mar. 26, 2014
(86) PCT No.: PCT/EP2014/056023

§ 371 Date: Oct. 21, 2015

(30) Foreign Application Priority Data
Apr. 22, 2013 (DE) 10 2013 207 241.4

(51) Int. Cl. H02K 3/24; H02K 9/08

(52) U.S. Cl. CPC H02K 3/24; H02K 9/08

(57) ABSTRACT

The invention relates to an electric machine comprising a rotor (2) aligned along a rotor axis (1), a stator (3) disposed concentrically with respect to the rotor axis (1) and at least one winding head (4) which is disposed concentrically with respect to the rotor axis (1), which projects in each case in the axial direction out of the stator and can be cooled by a coolant flow (5). In order to improve the cooling of the winding head (4), the electric machine of the aforementioned type has, according to the invention, at least one first conducting element (6) which in terms of the flow is disposed upstream of the respective winding head (4), wherein the at least one first conducting element (6) is designed in such a way that an increase in the flow rate of the coolant flow (5) to the respective winding head (4) can be effected.

The invention relates to an electric machine having a rotor aligned along a rotor axis, a stator disposed concentrically with respect to the rotor axis and at least one winding head which is disposed concentrically with respect to the rotor axis, which projects in each case in the axial direction out of the stator and can be cooled by a coolant flow.

The winding heads of the windings of electric machines project axially out of the magnetic active parts and require a separate cooling, which is realized in most instances by a circulating cooling fluid. Particularly in machines with a larger diameter or lower rotational speeds, the winding heads of which are cooled using air or another gaseous medium, in most instances only one minimal thermal transfer coefficient can be realized on account of lower flow rates.

The gaseous cooling fluids usually flow through the winding head in a predominantly radial and in part axial direction, wherein this takes place largely evenly when viewed across the entire periphery.

DE 10 2008 033 959 A1 discloses an electric machine, the winding heads of which can be cooled by cooling air which flows radially outwards, said cooling air then being deflected in the peripheral direction by means of a conducting sheet in each case. Here the conducting sheet is arranged radially further outwards than the respective winding head and covers at least three quarters of the periphery, so that the cooling air can flow radially outwards through the remaining opening of a maximum of one quarter of the periphery.

The object underlying the invention is to improve the cooling of the winding head of an electric machine.

This object is achieved with an electric machine of the type cited in the introduction by at least one first conducting element, which in terms of the flow is disposed upstream of the respective winding head, wherein the at least one first conducting element is designed in such a way that an increase in the flow rate of the coolant flow to the respective winding head can be effected.

By means of the at least one first conducting element, a coolant flow, which in terms of the flow points upstream of the first conducting element for instance consistently in the direction of the respective winding head, can be intentionally accelerated. This can be achieved in that the at least one first conducting element is arranged upstream of the respective winding head and the coolant thus flows directly against the respective first conducting element. Increasing the flow rate of the coolant flow then results in the at least one first conducting element causing a tapering-off of the flow cross-section available for the coolant flow. An improved cooling of the respective winding head is achieved by the increased flow rate of the coolant flow to the respective winding head.

For instance, the at least one first conducting element can be arranged in any axial region of the electric machine, in which the respective winding head is also disposed, wherein the at least one first conducting element is arranged radially further inwards than the respective winding head. The coolant flow points accordingly from radially inwards to radially outwards and is generated for instance by a ventilator arranged in the same axial region. Alternatively, the coolant flow can point from radially outside to radially inside and the at least one first conducting element is arranged correspondingly radially further outwards than the respective winding head. It is also conceivable for a ventilator arranged on the respective axial front face of the electric machine to generate the coolant flow, so that the coolant flow first points to the axial center and in the axial region of the winding head is deflected for instance by a deflection element into a coolant flow which points radially outwards. In both instances the coolant flowing consistently radially outwards thus strikes the at least one first conducting element. The at least one first conducting element can be embodied here for instance as essentially hollow cylindrical. Moreover, the flow direction of the coolant flow can be deflected by the at least one first conducting element in the peripheral direction. To this end, the at least one first conducting element can have additional deflection elements for instance.

Alternatively, the at least one first conducting element can be arranged in an axial region of the electric machine, which lies between the respective front face and the respective winding head of the electric machine. The coolant flows accordingly in the axial direction from the respective front face in the direction of the respective winding head of the electric machine and can be generated for instance by means of a ventilator. Therefore the coolant flowing consistently in the axial direction to the axial center of the electric machine strikes the at least one first conducting element. The at least one first conducting element can be embodied here for instance as essentially annular or disc-shaped. Moreover, the at least one first conducting element can have additional deflection elements, which deflect the coolant in the peripheral direction.

The deflection of the coolant flow in the peripheral direction can in this case effect a further improvement in the cooling of the respective winding head, since the respective winding head for a coolant flow with a flow component in the peripheral direction is more easily accessible and the points of the respective winding head which are thus otherwise difficult to access can be cooled down more easily.

The at least one first conducting element can be embodied here in the peripheral direction to be completely or only partially surrounded, wherein the at least one first conducting element can be arranged here essentially concentrically with respect to the rotor axis.

In an advantageous embodiment of the invention, the at least one first conducting element has first recesses.

The first recesses can also be embodied here as first openings, for instance in the form of first boreholes which pass through the at least one first conducting element. Here the first recesses or the first openings can extend or taper in the flow direction for instance. If a deflection of the coolant flow is additionally to be achieved in the peripheral direction, the first recesses or openings cannot be aligned precisely along the initial flow direction, but instead have additionally a component in the peripheral direction.

With a coolant flow which runs firstly in the radial direction, the first recesses can be embodied for instance as boreholes introduced into the at least one first conducting element in the radial direction. In order to achieve a deflection of the flow direction in the peripheral direction, the corresponding boreholes do not point precisely radially outwards, but instead run in each case along a line, which has another component in the peripheral direction in each case.

With a coolant flow which runs firstly in the axial direction, the first recesses can be embodied for instance accordingly as boreholes introduced into the at least one first conducting element in the axial direction. In order to achieve a deflection of the flow direction in the peripheral direction, the corresponding boreholes do not point precisely in the axial direction, but instead additionally have a component in the peripheral direction.

The said first recesses or first openings of the at least one first conducting sheet can function here as nozzles in respect of the coolant flow, said nozzles tapering the flow cross-section for the coolant flow and thus causing an increase in the flow rate. At the same time the nozzles advantageously produce the deflection of the coolant flow in the peripheral direction, so that the first recesses or first openings can be embodied as deflection nozzles.

In an advantageous embodiment of the invention, the at least one winding head has electrical conductors here, between which the respective winding head has cooling channels, wherein the coolant flow can be conducted into at least one part of the cooling channels by means of the first recesses.

The cooling channels can be formed here for instance such that an electrical conductor is arranged in each case at a defined distance from the next adjacent electrical conductor. In particular, the electrical conductors run in grooves in the stator of the electric machine, wherein the distance between two grooves corresponds approximately to the width of such a cooling channel. The first recesses of the at least one first conducting element are arranged here such that the coolant flow through the first recesses can be conducted into at least one part of the cooling channels, wherein preferably all cooling channels can be supplied with the coolant flow.

The cooling channels generally run in the radial direction, in other words in the same direction as the grooves are introduced into the stator. Since the electrical conductors are guided from one groove into another groove, cooling channels are however not always rotated precisely in the axial direction, but instead in part in the peripheral direction.

With an initial radial flow direction, the at least one first conducting element is preferably embodied such that the coolant flow is introduced in particular along the entire axial region of the respective winding head into the radially inner-lying or radially outer-lying openings of the cooling channels, wherein the position of the respective openings in the cooling channels along the axial direction can vary in sections in the peripheral direction in the manner similar to a screw shape.

With an initial axial flow direction, the at least one first conducting element is preferably embodied such that a deflection of the coolant flow can be achieved in each peripheral direction, in which the conductors of the winding head are also rotated.

The at least one first conducting element adjusted to the respective initial flow direction of the coolant flow thus effects a particularly good coolant supply of the respective winding head, so that the conductors of the winding head can be reliably cooled at all points.

In a further advantageous embodiment of the invention, the at least one first conducting element is configured here at least in sections in the manner of a propeller blade between at least one pair of first recesses.

By means of the at least sectional embodiment of the at least one first conducting element in the form of a propeller blade, the increase in the flow rate of the coolant flow toward the respective winding head can be effected on the one hand and on the other hand an advantageous deflection of the coolant flow in the peripheral direction can be achieved in an efficient manner. In addition, this embodiment of the at least one first conducting element also allows for the reduction in flow losses of the coolant flow.

With a first radial flow direction, the propeller blade, like a propeller blade of a ventilator, which can generate a radial flow direction of a coolant, or with a first axial flow direction for instance similar to a propeller blade of a ventilator, which can generate an axial flow direction of a coolant. For the radial flow direction, the propeller blade can be shaped for instance like a propeller blade of a radial ventilator and for the axial flow direction for instance like a propeller blade of an axial ventilator. The shaping of the propeller blade like a propeller blade of a half axial fan or other ventilators which can generate the desired flow direction of the coolant is also conceivable. The respective propeller blade can generally be embodied here to be flat or in terms of the flow to be efficiently curved in order to further minimize flow losses.

In particular, the at least one first conducting element is embodied overall as a propeller having several propeller blades which are adjusted to the respective incoming coolant flow.

In a further advantageous embodiment of the invention, the electric machine has at least one second conducting element, which in terms of flow is disposed downstream of the respective winding head, wherein the at least one second conducting element has second recesses.

The advantageous windings of the at least one first conducting element, which is arranged upstream of the respective winding head, can be assisted particularly effectively by the at least one second conducting element, which is arranged downstream of the respective winding head. Then by means of the at least one second conducting element the coolant flow can be guided through the at least one first conducting element and the respective winding head such that overall the flow losses can be reduced and the cooling effect of the coolant flow can thus be improved at the respective winding head. Moreover, the at least one second conducting element allows for an additional increase in the flow rate of the coolant flow on the respective winding head, which likewise improves the cooling effect. Here the second recesses in the flow direction can be embodied for instance as nozzles or diffusers.

In a further advantageous embodiment of the invention, the second recesses are arranged here in each case offset from the first recesses. The offset arrangement of the second recesses in respect of the respective position of the first recesses can further increase the flow rate of the coolant flow. In particular, it can be ensured that the respective winding head is supplied in its entirety as well as possible with the coolant flow. This thus enables an additional improvement in the cooling effect on the respective winding head. Here the offset of the second recesses in respect of the first recesses can take place in the axial direction or in the peripheral direction, wherein a further deflection of the coolant flow in the peripheral direction can be achieved at the same time on account of the offset in the peripheral direction.

In a further advantageous embodiment of the invention, the at least one second conducting element is embodied here in the manner of a propeller blade at least in sections between at least one pair of second recesses.

As a result of the at least one second conducting element being configured at least in sections in the form of a propeller blade, an increase in the flow rate of the coolant flow to the respective winding head can in turn be effected. In addition, this embodiment of the at least one second conducting element allows for the reduction in flow losses of the coolant flow.

Here the respective propeller blade can be embodied in a similar manner to a propeller blade of a ventilator as a function of the flow direction of the coolant flow which flows out of the respective winding head, and can be embodied here to be flat or in terms of the flow to be efficiently curved in order to further minimize the flow losses.

In particular, the at least one second conducting element is embodied overall as a propeller with a number of propeller blades which is adjusted to the respective incoming coolant flow.

In a further advantageous embodiment of the invention, the respective winding head is arranged here in the radial direction between the at least one first conducting element and the at least one second conducting element, wherein at least one ring-shaped conducting element is arranged in the axial extension of the respective winding head, said conducting element extending in the radial direction at least from at least one first conducting element to at least one second conducting element.

The at least one ring-shaped conducting element ensures here that the coolant flow flowing radially outwards cannot escape in the axial direction. This is particularly advantageous if the at least one first conducting element and/or the at least one second conducting element brings about a tapering off of the flow cross-section in the radial direction. The coolant then passes coming from radially inwards through the at least one first conducting element, flows radially outwards through the respective winding head and is guided here in the axial direction on the one hand through the stator and on the other hand radially further outwards through the at least one ring-shaped conducting element. Finally the coolant passes radially outwards through the at least one second conducting element. Alternatively, the coolant flow can also point in the reverse direction, in other words from radially outwards to radially inwards, wherein the at least one first conducting element is then arranged radially further outwards than the respective winding head and the at least one second element is arranged radially further inwards than the respective winding head in accordance with the conducting element. The respective radial guidance of the coolant flow allows for a particularly efficient cooling effect on the respective winding head.

An additional improvement in the cooling of the winding head can be effected for instance by further recesses in the at least one ring-shaped conducting element, if an additional coolant flow is introduced through these further recesses in the axial direction into the region of the winding head.

The electric machine preferably has at least one ventilator for generating the coolant flow.

In a further advantageous embodiment of the invention, the electric machine can be operated with an output of more than 1 MW and/or a rotational speed of less than 750 rpm, in particular less than 200 rpm.

With electric machines of this type, a comparably large quantity of waste heat which has to be efficiently and reliably transported away is produced during operation on the respective winding head. In general, electric machines are particularly problematic in this respect, which have comparably low operating rotational speeds and are only cooled by means of a ventilator connected to the rotor of the electric machine, since accordingly also the ventilator is only operated with low rotational speeds and can circulate comparably small quantities of coolant. On account of the afore-described embodiments of the inventive electric machine, an adequate cooling of the respective winding head can however also be ensured with low operating speeds.

The invention is described and explained in more detail below on the basis of the exemplary embodiments shown in the Figures, in which:

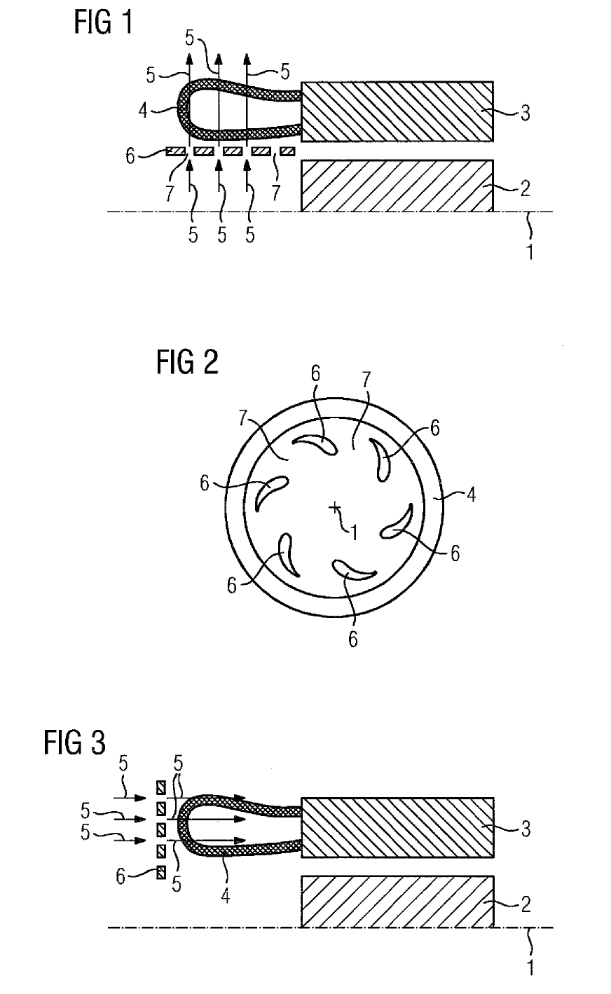

FIG. 1 shows a first exemplary embodiment of the inventive electric machine with first radial coolant flow,

FIG. 2 shows an example of a first conducting element for the first exemplary embodiment,

FIG. 3 shows a second exemplary embodiment with first axial coolant flow,

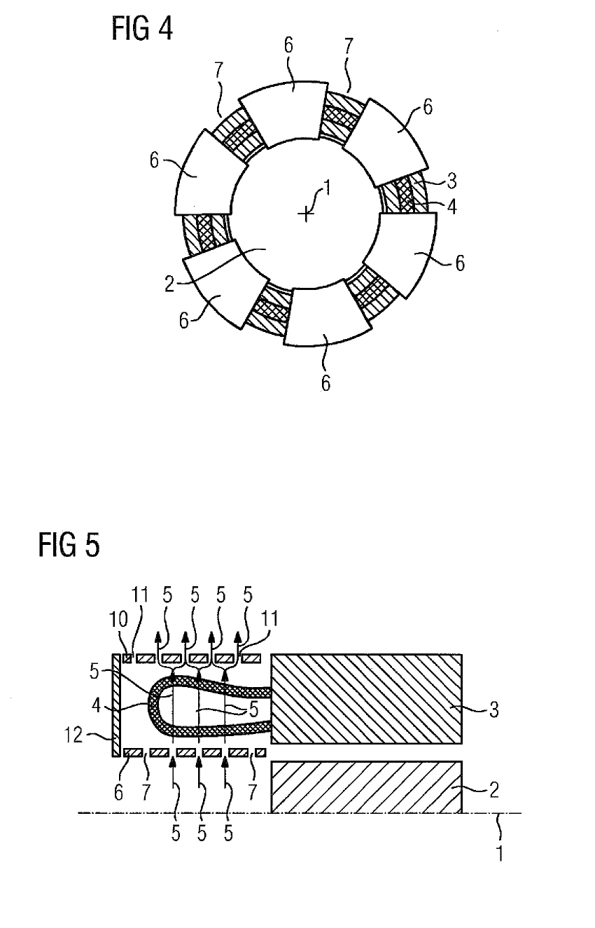

FIG. 4 shows an example of a first conducting element for the second exemplary embodiment,

FIG. 5 shows a third exemplary embodiment, and

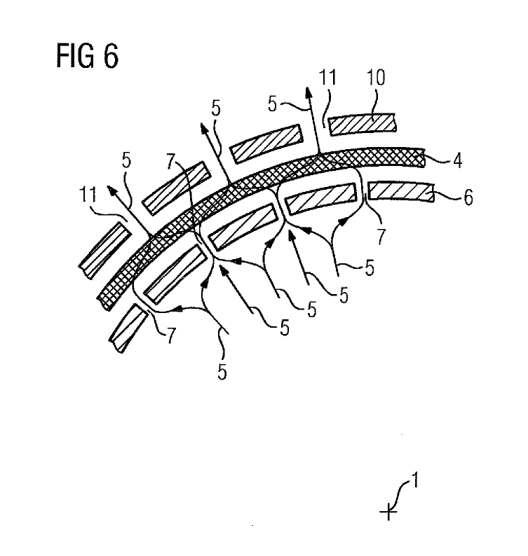

FIG. 6 shows a fourth exemplary embodiment.

FIG. 1 shows a first exemplary embodiment of the inventive electric machine with first radial coolant flow 5, wherein a cutout of a longitudinal section of the electric machine is shown. The electric machine has a stator 3 and a rotor 2, which are both aligned along a rotor axis 1. A winding head 4 protrudes from the stator 3 at both axial ends, wherein for the sake of clarity the winding head 4 is only shown in more detail on one front face of the electric machine.

The winding head 4 can be cooled by the coolant flow 5, which within the scope of this exemplary embodiment flows from radially inwards to radially outwards. A first conducting element 6, which effects an increase in the flow rate of the coolant flow 5 to the winding head 4, is arranged upstream of the winding head 4, in other words in the axial region of the winding head 4 and radially further inwards than the winding head 4. Within the scope of the first exemplary embodiment, the first conducting element 6 to this end has first recesses 7, which taper the flow cross-section for the coolant flow 5 flowing radially outwards onto the winding head 4.

Within the scope of the first exemplary embodiment, the first conducting element 6 covers the winding head 4 with a radial top view onto the winding head 4 from radially inwards to radially outwards, since the axial extent of the first conducting element 6 is at least as large as the axial extent of the winding head 4. Alternatively provision can however also be made for the axial extent of the first conducting element 6 to be smaller than the axial extent of the winding head 4.

The coolant flow 5 flowing radially outwards can be generated for instance by means of a ventilator, which is arranged for instance in the axial region of the winding head 4 and radially further inwards than the winding head 4. Alternatively, a ventilator can also be used for this, which firstly generates a coolant flow 5, which flows in the axial direction from the axial front face of the electric machine to the axial center, and is deflected radially outwards in the axial region of the winding head 4, in particular by means of a deflection element.

Alternatively, the coolant flow 5 can point from radially outwards to radially inwards and the first conducting element 6 is arranged accordingly radially further outwards than the winding head 4.

FIG. 2 shows an example of a first conducting element 6 for the first exemplary embodiment of the electric machine, wherein an axial top view, based on one of the front faces of the electric machine, is shown. Here the same reference characters refer to the same objects in FIG. 1. For the sake of clarity, only the rotor axis 1, the first conducting element 6, the first recesses 7 and the winding head 4 are shown.

The first conducting element 6 is embodied such that the coolant flow 5 coming from radially inwards is deflected by the first conducting element 6 in the peripheral direction and in the process the flow rate of the coolant flow 5 is increased. This is achieved in that the first conducting element 6 is formed in sections like a propeller blade between a pair of recesses 7. To this end the first conducting element 6 has in particular blade-shaped elements, which are embodied in a similar manner to a propeller blade, in particular a ventilator, for instance a radial ventilator. The respective propeller blade can be embodied here to be flat or in terms of the flow to be efficiently curved in order to further minimize flow losses.

FIG. 3 shows a second exemplary embodiment of the inventive electric machine with first axial coolant flow 5. Contrary to the first exemplary embodiment, the coolant flow 5 in the second exemplary embodiment flows in the axial direction from the axial front face of the electric machine to its axial center. The first conducting element 6 is in turn arranged upstream of the winding head 4, by the first conducting element 6 now being arranged on the axial end of the winding head 4. Within the scope of the exemplary embodiment, the first conducting element 6 to this end has first recesses 7, which taper the flow cross-section for the coolant flow 5 flowing axially onto the winding head 4.

Within the scope of the second exemplary embodiment, the first conducting element 6 covers the winding head 4 with an axial top view onto the winding head 4, since the radial extent of the first guiding element 6 is at least as large as the radial extent of the winding head 4. Alternatively, provision can however also be made for the radial extent of the first conducting element 6 to be smaller than the radial extent of the winding head 4.

The axially flowing coolant flow 5 can be generated by a ventilator for instance, which is arranged for instance on the axial front face of the electric machine. Alternatively, a ventilator can also be used here, which is arranged in particular on the axial front face of the electric machine and firstly generates a coolant flow 5, which flows in the radial direction. For instance, the coolant flow flowing radially outwards can then be deflected in the axial direction by a deflection element, in order finally to flow in the axial direction to the winding head 4.

FIG. 4 shows an example of a first conducting element 6 for the second exemplary embodiment of the electric machine, wherein an axial top view, based on one of the front faces of the electric machine, is shown. For the sake of clarity, only the rotor axis 1, the first conducting element 6, the first recesses 7 and the winding head 4 and the rotor 2 and the stator 3 are shown, wherein the rotor 2 and the stator 3 are partially concealed by the first conducting element 6 or the winding head 4 in this view.

The first conducting element 6 is embodied such that the coolant flow 5 coming from the axial front face of the electric machine is deflected by the first conducting element 6 in the peripheral direction and the flow rate of the coolant flow 5 is thus increased. This is achieved in that the first conducting element 6 is shaped in sections like a propeller blade between a pair of recesses 7. To this end the first conducting element 6 has in particular blade-shaped elements, which are configured in a manner similar to a propeller blade, in particular a ventilator, for instance an axial ventilator. The respective propeller blade can be embodied here to be flat or in terms of the flow to be efficiently curved in order to further minimize flow losses.

FIG. 5 shows a third exemplary embodiment of the inventive electric machine, wherein the third exemplary embodiment has firstly the same design as the first exemplary embodiment.

In addition, a second conducting element 10 is provided, which is arranged downstream of the winding head, in other words in the axial region of the winding head 4 and radially further outwards than the winding head 4. The second conducting element 10 here has second recesses 11, which cause an additional increase in the flow rate of the coolant flow 5. To this end, the second recesses 11 are arranged offset to the first recesses 7, wherein within the scope of the third exemplary embodiment the offset is in the axial direction. The second conducting element 10 can be embodied here similarly to the first conducting element shown in FIG. 2.

In comparison with the first exemplary embodiment, the electric machine of the third exemplary embodiment additionally has a ring-shaped conducting element 12, which is arranged in the axial extent of the winding head 4 and ensures that the coolant flow 5 does not leave the region of the winding head 4 in the axial direction. To this end, the ring-shaped conducting element 12 is arranged in the axial extent of the first conducting element 6 and the second conducting element 10 and extends in the radial direction at least from the first conducting element 6 to the second conducting element 10.

In principle, it is conceivable here that the ring-shaped conducting element 12 has further recesses, through which an additional coolant flow is introduced in the axial direction into the region of the winding head 4, in order to further improve the cooling of the winding head 4.

It is also conceivable to embody the electric machine without the ring-shaped conducting element 12.

Alternatively, the coolant flow 5 can point from radially outwards to radially inwards and the first conducting element 6 can be arranged accordingly radially further outwards than the winding head 4 and the second conducting element 10 can be arranged accordingly radially further inwards than the winding head 4.

FIG. 6 shows a fourth exemplary embodiment of the inventive electric machine, wherein the fourth exemplary embodiment has firstly the same design as the third exemplary embodiment and wherein a cutout of a cross-section of the electric machine is shown at the axial height of the winding head 4. Contrary to the third exemplary embodiment, the offset between the first conducting element 6 and the second conducting element 10 in the fourth exemplary embodiment is in the peripheral direction, as a result of which a particularly advantageous deflection of the coolant flow 5 is effected in the peripheral direction, which results in an improved cooling of the winding head 4.

Here the electric machine can also be embodied without the ring-shaped conducting element 12. Moreover, the coolant flow 5 can alternatively point from radially outwards to radially inwards and the first conducting element 6 can be arranged accordingly radially further outwards than the winding head 4 and the second conducting element 10 can be arranged accordingly radially further inwards than the winding head 4.

In summary, the invention relates to an electric machine comprising a rotor aligned along a rotor axis, a stator disposed concentrically with respect to the rotor axis and at least one winding head which is disposed concentrically with respect to the rotor axis, which projects in each case in the axial direction out of the stator and can be cooled by a coolant flow. In order to improve the cooling of the winding head, it is proposed that the electric machine of the aforementioned type has at least one first conducting element which in terms of the flow is disposed upstream of the respective winding head, wherein the at least one first conducting element is designed in such a way that an increase in the flow rate of the coolant flow to the respective winding head can be effected.

1.-10. (canceled)

11. An electric machine, comprising:
a rotor defining a rotor axis;
a stator arranged in concentric relationship to the rotor axis;
at least one winding head arranged in concentric relationship to the rotor axis and sized to project in a direction of the rotor axis out of the stator;
a coolant flow to cool the winding head;
at least one first conducting element arranged upstream of the winding head, as viewed in a direction of the coolant flow, said at least one first conducting element configured to increase a flow rate of the coolant flow to the winding head;
at least one second conducting element arranged downstream of the winding head, as viewed in the direction of the coolant flow, said at least one second conducting element having recesses, said winding head being arranged in a radial direction between the at least one first conducting element and the at least one second conducting element; and
at least one ring-shaped conducting element arranged in axial prolongation of the winding head and configured to extend in the radial direction at least from at least one first conducting element to the at least one second conducting element.

12. The electric machine of claim 11, wherein the at least one first conducting element has recesses.

13. The electric machine of claim 12, wherein the at least one winding head has electrical conductors, between which the winding head has cooling channels, said coolant flow being guided for conduction into at least one part of the cooling channels via the recesses of the at least one first conducting element.

14. The electric machine of claim 12, wherein the at least one first conducting element has at least one section which is configured in a manner of a propeller blade between at least one pair of the recesses of the at least one first conducting element.

15. The electric machine of claim 12, wherein the recesses of the at least one second conducting element are arranged in offset relation to the recesses of the at least one first conducting element.

16. The electric machine of claim 11, wherein the at least one second conducting element has at least one section configured in a manner of a propeller blade between at least one pair of recesses of the at least one second conducting element.

17. The electric machine of claim 11, further comprising at least one ventilator for generating the coolant flow.

18. The electric machine of claim 11, constructed for operation with an output of more than 1 MW and/or a rotational speed of less than 750 rpm.
